(19) United States
(12) Patent Application Publication
(10) Pub. No.: US 2014/0307762 A1
(43) Pub. Date: Oct. 16, 2014

(54) COMMUNICATION SYSTEM FOR MANAGING LEASED LINE NETWORK AND A METHOD THEREOF

(71) Applicant: CENTER FOR DEVELOPMENT OF TELEMATICS (C-DOT), Bangalore (IN)

(72) Inventors: Sastry Vvr, Bangalore (IN); Jayant Bhatnagar, Bangalore (IN); Shanker A. Bhavani, Bangalore (IN); Sai Jayram Akv, Bangalore (IN); Suresh Br, Bangalore (IN); Ramanjaneya P. Reddy, Bangalore (IN); Cherukuri Vds Chowdary, Bangalore (IN)

(21) Appl. No.: 14/354,366

(22) PCT Filed: Oct. 17, 2012
(86) PCT No.: PCT/IB2012/055645

§ 371 Date: Apr. 25, 2014

(30) Foreign Application Priority Data
Oct. 27, 2011 (IN) 3683/CHE/2011

(51) Int. Cl. H04M 3/00

(52) U.S. Cl. CPC H04M 3/007
USPC 375/222

(57) ABSTRACT

Embodiments of the present disclosure relate to a communication system for managing leased line networks. The system comprises of a router to route data from one network to another network, and a V.35 modem configured to receive the data from the router and transmit the data to a predefined destination using internet protocol (IP) network. The interface which connects the router with the V.35 modem is a V.35 interface. The IP network requires an ethernet interface to receive the data and to transmit the data to a destined location. The V.35 modem designed converts the V.35 interface to an ethernet interface, but since the ethernet interface is expensive, the V.35 modem converts the ethernet interface to an ADSL interface for establishing ADSL connection towards the IP network.

### TECHNICAL FIELD

The present disclosure relates to communication network. More particularly the embodiments of the disclosure relate to a communication system for managing leased line networks.

### BACKGROUND

Network architecture for managing leased line networks is shown in FIG. 1. Leased lines are used to connect networks of two locations of an organization using a nailed up dedicated path. The dedicated path is through E1/HDSL interfaces routed through PSTN switches. The architecture comprises of a router, a V35 modem and a PSTN exchange. Router aggregates the IP links in an organization and puts on a V35 interface of WAN port or the router. Wan port is connected to V.35 modem on a V.35 interface connector. V35 modem receives the IP data through V35 interface and transmits the received data towards PSTN either on G703 (E1 interface) or HDSL interface. Both G703 and HDSL are E1 interfaces with different line encoding standards. PSTN switch is connected to the E1 interfaces to receive the IP data and routes to a different location using its own E1 network towards other end of V35 modem and finally to a router.

The disadvantage with this scenario is, as the requirements of leased lines increases, the interconnecting E1 interfaces between PSTN switches in the network should also grow. This cannot happen in all scenarios because there may not be E1s available to all locations. The Operating expense (Opex) and Capital expenditure (Capex) of the leased line network is very high due to the maintenance requirement of the dedicated lines. This cost will ultimately be passed on to the user. This solution is not only expensive but also the equipment required for this solution is expensive due to volumes.

Hence, there exists a need for a system or architecture to solve all the above problems of providing increased connectivity and low maintenance cost.

### SUMMARY

The shortcomings of the prior art are overcome and additional advantages are provided through the provision of a method and system as described in the description.

The present disclosure solves the limitations of existing techniques by providing improved and easy access to the users for managing the network connected devices without line of sight requirement.

Additional features and advantages are realized through the techniques of the present disclosure. Other embodiments and aspects of the disclosure are described in detail herein and are considered a part of the claimed disclosure.

In one embodiment, the present disclosure provides a system for managing leased line networks comprising, a router to route data from one network to another network. The system also includes a modem configured to receive data and transmit the data to a predefined destination using internet protocol (IP) network. The data is either from a router or an IP network. The modem comprises a physical interface block to receive the data using an interface to generate a predetermined data signals. The modem also includes an ethernet processor block to receive the predetermined data signals to generate ethernet packets and an Asymmetric Digital Subscriber Line (ADSL) processor block to receive the ethernet packets to generate ADSL data. The ADSL processor block establishes communication between the modem and the internet protocol (IP) network through existing Digital Subscriber Line Access Multiplexer (DSLAMS) in PSTN network. The interface block connected to the ADSL processor block to perform at least one of transmitting the ADSL data onto the IP network and receiving data from the IP network. An ethernet interface block receives the ethernet packets and transmits the ethernet packets onto the IP network. The system also includes a power supply to provide predetermined voltage to the modem from an external power supply.

In one embodiment, the predetermined signals generated by the physical interface block are transistor-transistor logic (TTL) signals.

In one embodiment, the modem comprises of a TDM processor block to receive data from the physical interface block to generate TDM frames.

In one embodiment, the modem in accordance with the present disclosure supports bandwidth up to 8 Mbps over V.35 and also supports 10/100 ethernet interface.

In one embodiment, the present disclosure provides a method of communication in a leased line network; said method includes receiving one or more data packets by a modem from a predefined source. The method also includes performing a predetermined operation on received data packets to generate predefined data signals. The predetermined operation is one of either encrypting or decrypting operation based on the predefined source, and transmitting the predefined data signals from the modem to a destination using an internet protocol (IP) network.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 illustrates a communication system for managing leased line networks, as a prior art.

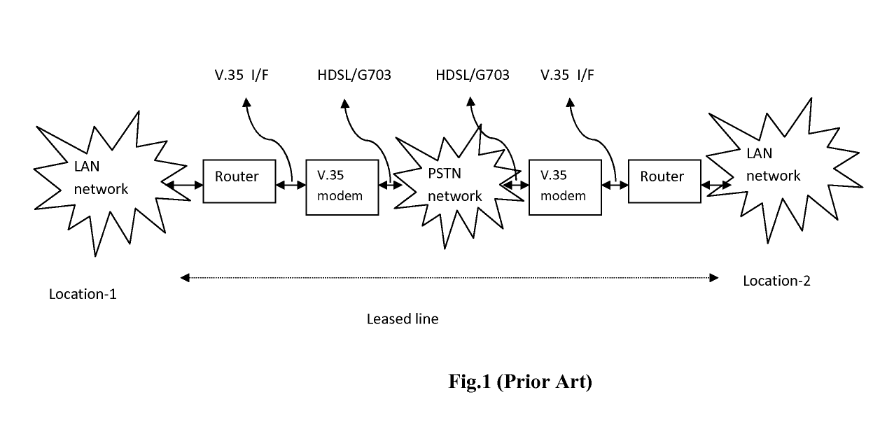

FIG. 2 illustrates a communication system for managing leased line networks in accordance with an embodiment of the present disclosure.

FIG. 3 is an exemplary block diagram of a modem in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

An exemplary embodiment of the present disclosure is a communication system for managing leased line networks. The leased line connects two locations for data telecommunication service and is a reserved circuit between two points, The leased lines can span short or long distances. They maintain a single open circuit at all times, as opposed to traditional telephone services that reuse the same lines for many different conversations through a process called switching. The leased lines are used to connect networks of two locations of an organization using a nailed up dedicated path.

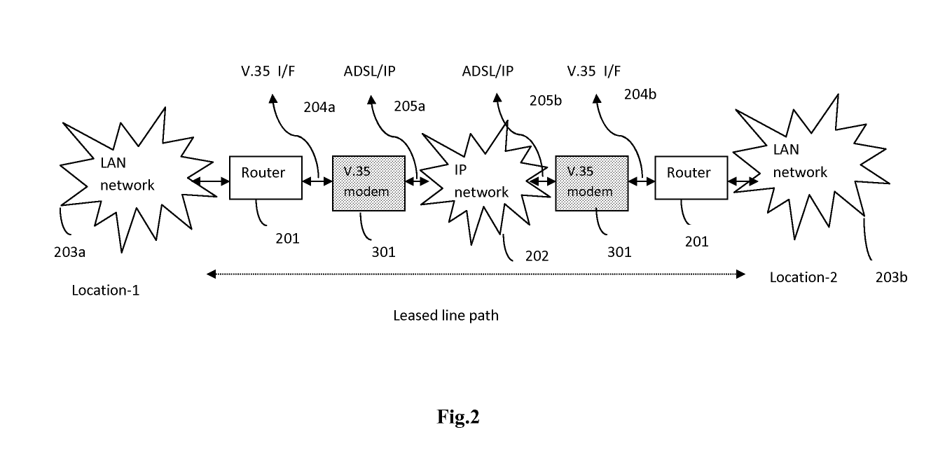

FIG. 2 illustrates a system for managing leased line networks in accordance with an embodiment of the present disclosure. The system comprises of a router 201, V.35 modem 301 and an IP network 202 for transmitting data from one location to another location, as an example from location 203a to location 203b as shown in FIG. 2. The router 201 aggregates the data from the location 203a and puts on a V.35 interface 204a of Wireless Area Network (WAN) port or the router 201. The V.35 interface is a high speed serial interface designed to support both higher data rates and connectivity between data terminal equipment (DTEs) over digital lines. The WAN port is connected to a V.35 modem 301 on a V.35 interface connector 204a. The V.35 modem 301 takes in the data through the V.35 interface 204a, which is a high level data link control (HDLC) data, i.e the HDLC protocol embeds information in the data that allows V.35 modem 301 to control data flow and correct errors. The V.35 modem 301 encapsulates the HDLC data in an ethernet MAC frame and forms an ethernet packet. The V.35 modem 301 converts the ethernet packet to Asymmetric Digital Subscriber Line (ADSL) towards ADSL interface 205a and send the data to the IP network 202 through already established ADSL connection.

The ADSL enables faster data transmission over copper telephone lines than a conventional voice band modem can provide. Further, the V.35 modem 301 performs encryption of the data for mission critical applications. The IP network 202 through the ADSL interface 205b sends the encrypted data to the V.35 modem 301. The V.35 modem 301 converts the ADSL interface 205b to the V.35 interface 204b. Further the V.35 modem 301 decrypts the received data from the IP network 202 and transmits the decrypted data to a router 201 associated with location 203b through the V.35 interface 204b. The router 201 routes the decrypted data to the destined location which is location 2 i.e 203b.

In one embodiment, the present disclosure provides a method of communication between networks of two locations. Firstly, one or more data packets are transmitted from a source location 203a to a router 201. The router 201 routes the data packets to a V.35 modem 301 through a V.35 interface 204a. The V.35 modem 301 transmits the data packets to an IP network 202 through an ADSL interface 205a. The IP network 202 requires an ethernet interface to receive the data packets from the V.35 modem 301 which is expensive and has a lot of cable pairs. Also, if the location of the router 201 and the IP network 202 is far the expenses will further more. To overcome this, the V.35 modem 301 converts the ethernet interface to an ADSL interface 205a. The ADSL interface 205a makes use of existing TIP/RING of telephone lines. Telephone lines are more common and available at all places. In one embodiment, the V.35 modem 301 encrypts the data packet and transmits the encrypted data packet to the IP network 202. The IP network 202 transmits the encrypted data packet to the V.35 modem 301 through the ADSL interface 205a. The V.35 modem 301 converts the ADSL interface 205b to the V.35 interface 204b and transmits the data. The V.35 modem 301 decrypts the data packets and transmits the data packets to the router 201 associated with the network 203b through the V.35 interface 204b. The router 201 routes the data packets to the destined location 203b.

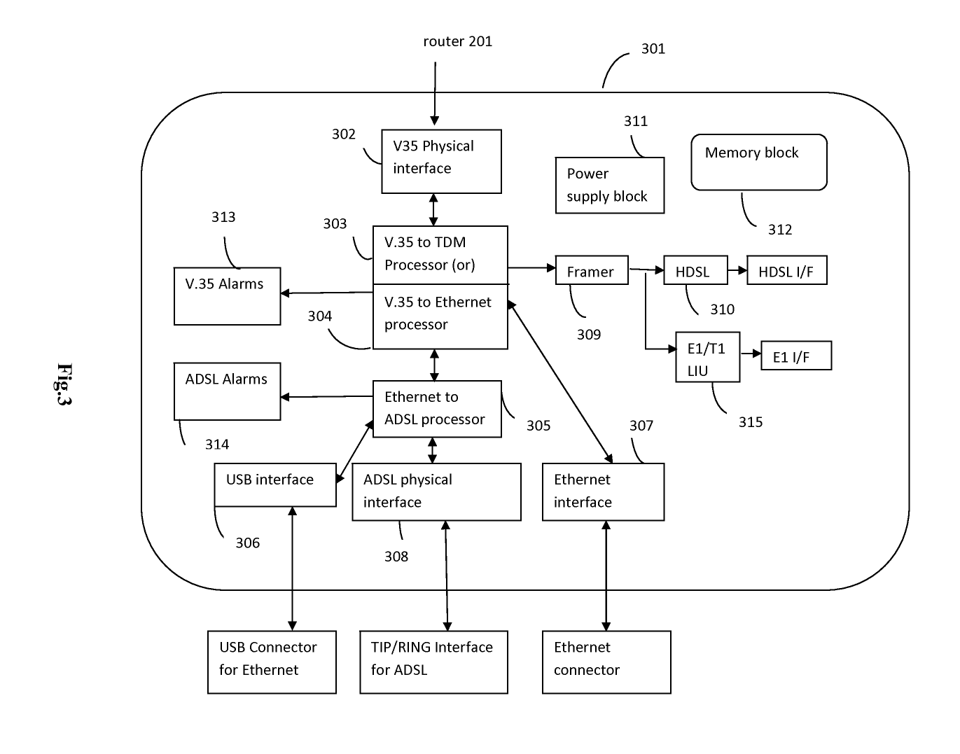

FIG. 3 is an exemplary block diagram of a V.35 modem 301 in accordance with an embodiment of the present disclosure. The V.35 modem 301 comprises of a V.35 physical interface block 302, a power supply block 311, a V.35 to TDM processor block 303, a V.35 to ethernet processor block 304, an ethernet to ADSL processor block 305, a memory block 312, a V.35 alarm block 313, a ADSL alarm block 314, a ADSL physical interface block 308, a USB interface block 306, and an ethernet interface block 307. The V.35 physical interface block 302 terminates the V.35 interface from a router 201 or any other device which is a DTE. Also, the V.35 physical interface block 302 converts differential V.35 signals to singled ended Transistor-Transistor Logic (TTL) signals and vice versa. In one embodiment, the TTL signals are then given to the V.35 to ethernet processor block 304. The V.35 to ethernet processor 304 block takes in the V.35 data, which is an HDLC data from the V.35 interface block, encapsulates an ethernet MAC frame and forms an ethernet packet. The ethernet packet will be given to the ethernet to ADSL processor block 305.

In one embodiment, the V.35 modem 301 comprises of a V.35 to TDM processor block 303. The V.35 to TDM processor block 303 receives the data from the V.35 physical interface block 302, encapsulates in TDM block and forms a TDM frame. The TDM frame is then given to a framer block 309. The framer block 309 receives the serial TDM frame from the V35 to TDM processor block and arranges the data into an E1 frame.

The E1 frames are then given to either G703 LIU interface block 315 or the HDSL LIU interface block 310. The E1 frames formed in the framer block 309 is coded to the HDSL format by the HDSL interface block 310 which can then be transmitted over the E1 line. The E1 frame formed in the framer block 309 is coded to the G703 coding in the G703 LIU interface block 315. The G703 LIU interface block 315 puts the data onto the TTIP and TRING and RTIP and RRING. Then the data can be transmitted over the E1 line which can go very long distances.

In one embodiment, the V35 physical interface block 302 does encryption of the data for mission critical applications. The ethernet to ADSL processor block 305 is implemented using standard ADSL chip. The ethernet to ADSL processor block 305 takes in the ethernet packet from the V.35 to ethernet processor block 304 and generates an ADSL signal towards ADSL interface. In one embodiment, the ethernet to ADSL processor block 305 establishes the ADSL connection towards the IP network 202, do maintenance of digital subscriber line (DSL) interface, perform Virtual Local Area Network (VLAN) tagging, and support Dynamic Host Configuration Protocol (DHCP) etc.

A VLAN is a method of creating independent logical networks within a physical network. VLAN Tagging is the practice of inserting a VLAN ID into a packet header in order to identify which VLAN the packet belongs to. More specifically, switches use the VLAN ID to determine which port(s), or interface(s), to send a broadcast packet to. DHCP is a network configuration protocol for hosts on Internet Protocol (IP) networks 202. The locations of an organization that are connected to IP networks 202 must be configured before they can communicate with each other. The most essential information needed is an IP address, and a default route and routing prefix. DHCP eliminates the manual task by a network administrator. It also provides a central database of devices that are connected to the network and eliminates duplicate resource assignments.

The ethernet to ADSL processor block 305 modulates high-frequency tones for transmission to a Digital Subscriber Line Access Multiplexer (DSLAM). The ethernet to ADSL processor block 305 receives and demodulates high-frequency tones from at least one of the DSLAM, supports voice, video and data, performs framing and line encoding, establishes the connection towards DSLAM, obtains the IP address from DNS server, provides option for firewall, provides option for VPN and VLAN tagging, performs as a router 201 between ethernet interface and ADSL interface or as a bridge between ethernet interface and ADSL interface.

The power supply block 311 configured in the V.35 modem 301 takes 12V DC power from an external power adaptor and generates all required voltages in V.35 modem 301 block to operate. The memory block 312 configured in the V.35 modem 301 is interfaced to the V.35 ethernet processor block 304 to store the software program, IP addresses, configuration parameters etc. The V.35 alarm block 313 displays various types of V.35 specific alarms. The ADSL alarm 314 block displays various types of ADSL specific alarms. An analog TIP/RING lines are connected to ADSL physical interface block to perform A/D conversion and two-four wire conversion, in one embodiment.

The USB interface block 306 is used to connect an external computer to V.35 modem 301 through USB for configuration and settings. The ethernet interface block 307 is a branched port from V.35 to ethernet processor block 304. This interface may be used in cases where ADSL is not available not required or when very high data rates are required. ADSL technology places a limitation on uplink data rate of 1.5 Mbps where as ethernet can go all the way up to 100 Mbps.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims

1. A modem for managing a leased line network comprising:
a physical interface block 302 to receive data using an interface and to generate predetermined data signals for the received data, wherein the data is either from a router 201 or an IP network 202
an ethernet processor block 304 to receive the predetermined data signals to generate ethernet packets;
ADSL processor block 305 to receive the ethernet packets to generate ADSL data, said ADSL processor block 305 establishes communication between the modem 301 and the internet protocol (IP) network 202; and
interface block (306,308) connected to the ADSL processor block 305 to perform at least one of transmitting the ADSL data onto the IP network 202 or receiving the data from the IP network 202.

2. The modem as claimed in claim 1 further comprises an ethernet interface block 307 to receive the ethernet packets and to transmit the ethernet packets onto the IP network 202;

3. The modem as claimed in claim 1, wherein the data received by the modem 301 is selected from a group comprising data from an IP network 202 that has to be decrypted and data from a source that has to be encrypted.

4. The modem as claimed in claim 1, wherein the interface which connects the router 201 with the physical interface block 302 is a V.35 interface 204.

5. The modem as claimed in claim 1, wherein the predetermined data signals generated by the physical interface block are transistor-transistor logic (TTL) signals.

6. The modem as claimed in claim 1, wherein the modem 301 comprises of a TDM processor block 303 to receive the predetermined data signals from the physical interface block 302 to generate TDM frames.

7. The modem as claimed in claim 6, wherein a framer block 309 is connected to the TDM processor block 303 to receive the TDM frames and generate E1 frames, said E1 frames are transmitted onto the IP network using at least one of HDSL interface block 310 and G703 interface block 315.

8. The modem as claimed in claim 1, wherein the interface block (306,308) comprises:
a USB interface block 306 consisting of one or more USB ports to provide communication, and
ADSL interface block 308 to establish communication between the modem 301 and the IP network 202 using telephone lines.

9. The modem as claimed in claim 8, wherein an analog TIP/RING lines are connected to the ADSL interface block 308 to transmit ADSL signals on the telephone lines

10. The modem as claimed in claim 8, wherein one of the USB port is configured to provide connection between the modem 301 and wireless network using a wireless USB dongle or networking USB dongle.

11. The modem as claimed in claim 1, wherein the modem 301 comprises of a memory block 312 interfaced with the ethernet processor block 304 to store predetermined parameters selected from a group comprising IP address of the router 201, configuration parameters of the modem 301, one or more applications of the modem 301 and configuration data of the modem 301.

12. A method for managing leased line network using a modem comprising acts of:
receiving data using an interface by a physical interface block 302 configured in the modem to generate predetermined data signals for the received data, wherein the data is either from a router 201 or an IP network 202;
receiving predetermined data signals by an ethernet processor block 304 to generate ethernet packets;
generating ADSL data by an ADSL processor block 305 upon receiving ethernet packets, wherein the ADSL processor block 305 establishes communication between the modem and the internet protocol (IP) network 202; and
performing at least one of:
transmitting the ADSL data onto the IP network by an interface block (306,308) connected to the ADSL processor block 305; and
receiving the data from the IP network 202 by the interface block (306,308).
